(19) United States
(12) Patent Application Publication
(10) Pub. No.: US 2022/0206206 A1
(43) Pub. Date: Jun. 30, 2022

(54) BACKLIGHT MODULE AND DISPLAY APPARATUS

(71) Applicant: Coretronic Corporation, Hsin-Chu (TW)

(72) Inventors: TA-HSIANG CHIU, Hsin-Chu (TW); Yan-Ching Lin, Hsin-Chu (TW); Wei-Hsuan Cheng, Hsin-Chu (TW)

(73) Assignee: Coretronic Corporation, Hsin-Chu (TW)

(21) Appl. No.: 17/562,993

(22) Filed: Dec. 27, 2021

(30) Foreign Application Priority Data
Dec. 29, 2020 (CN) 202023252118.3

(51) Int. Cl. F21V 8/00

(52) U.S. Cl. CPC G02B 6/0016; G02B 6/0058

(57) ABSTRACT

A backlight module including a light source, a light guide plate, an optical film set and at least one optical film layer is provided. The light guide plate has a light-incident surface and a light-emitting surface adjacent to the light-incident surface. The light source is disposed on a side of the light-incident surface and emits a light beam. The optical film set includes a first surface, a second surface opposite to the first surface and at least one side surface connected between the first surface and the second surface. The optical film set is disposed on a side of the light-emitting surface of the light guide plate, and the first surface faces the light-emitting surface. The optical film layer is disposed on the side surface of the optical film set. The optical film layer is a particle structure layer. A display apparatus including the backlight module is also provided.

### CROSS-REFERENCE TO RELATED APPLICATION

This application claims the priority benefit of China application serial no. 202023252118.3, filed on Dec. 29, 2020. The entirety of the above-mentioned patent application is hereby incorporated by reference herein and made a part of this specification.

### BACKGROUND

### Technical Field

The invention relates to an optical module and a display apparatus, and particularly relates to a backlight module and a display apparatus including the backlight module.

### Description of Related Art

Nowadays, current of displays are developing towards a thin design and a narrow bezel. However, a halo effect due to light leakage occurs frequently on the edge of an image in the visible region of a narrow bezel display.

Currently, common solutions against such light leakage in displays include: (1) attaching a light shielding tape; (2) printing ink on the light-emitting surface of a diffuser; and (3) adjusting a blank region of a light guide plate. However, since the ineffective region of a narrow bezel display is smaller than the ineffective region of a traditional display, given that the shielding area is limited, the three solutions above are still unable to entirely suppress the diffused light at the end/edge of an optical material.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

An aspect of the invention provides a backlight module capable of suppressing the occurrence of a halo effect due to light leakage.

Another aspect of the invention provides a display apparatus having the backlight module and therefore having favorable display effect.

Other objects and advantages of the invention can be further illustrated by the technical features broadly embodied and described as follows.

To realize one, some, or all of the above objectives or other objectives, an embodiment of the invention provides a backlight module. The backlight module includes a light source, a light guide plate, an optical film set and at least one optical film layer. The light guide plate has a light-incident surface and a light-emitting surface adjacent to the light-incident surface. The light source is disposed on a side of the light-incident surface of the light guide plate, and is configured to emit a light beam. The optical film set includes a first surface, a second surface and at least one side surface. The first surface is opposite to the second surface, and the at least one side surface is connected between the first surface and the second surface. The optical film set is disposed on a side of the light-emitting surface of the light guide plate, and the first surface faces the light-emitting surface. The at least one optical film layer is disposed on the at least one side surface of the optical film set. The at least one optical film layer is a particle structure layer.

A display apparatus according to an embodiment of the invention includes a backlight module and a display panel. The display panel is disposed on a light-emitting side of the backlight module. The backlight module includes a light source, a light guide plate, an optical film set, and at least one optical film layer. The light guide plate has a light-incident surface and a light-emitting surface adjacent to the light-incident surface. The light source is disposed on a side of the light-incident surface of the light guide plate, and is configured to emit a light beam. The optical film set includes a first surface, a second surface and at least one side surface. The first surface is opposite to the second surface, and the at least one side surface is connected between the first surface and the second surface. The optical film set is disposed on a side of the light-emitting surface of the light guide plate, and the first surface faces the light-emitting surface. The at least one optical film layer is disposed on the at least one side surface of the optical film set. The at least one optical film layer is a particle structure layer.

Based on the above, according to an embodiment of the invention, since at least one optical film layer is disposed on at least one side surface of the optical film set of the backlight module, the occurrence of a halo effect due to light leakage on the edge of the optical film set may be suppressed. In addition, since the optical film layer is a particle structure layer, the adhesion of the optical film layer to the optical film set is enhanced. Thus, the chance that the optical film layer is peeled off is reduced. In addition, in the backlight module, the stacking of the optical film layer is determined in accordance with design requirements. Therefore, the overall brightness and uniformity of the backlight module is facilitated.

Since the display apparatus according to an embodiment of the invention adopts the backlight module, the display apparatus has a favorable display effect.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic partial cross-sectional view taken along a direction perpendicular to a light-incident surface of a light guide plate in a display apparatus according to an embodiment of the invention.

FIG. 2 is a schematic partial cross-sectional view taken along a direction parallel to the light-incident surface of the light guide plate in the display apparatus according to an embodiment of the invention.

FIG. 3 is a schematic view illustrating an optical film set provided with an optical film layer.

FIG. 4 is a schematic side view illustrating particles stacking in the optical film layer.

FIG. 5 is a schematic top view illustrating particles stacking in the optical film layer.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

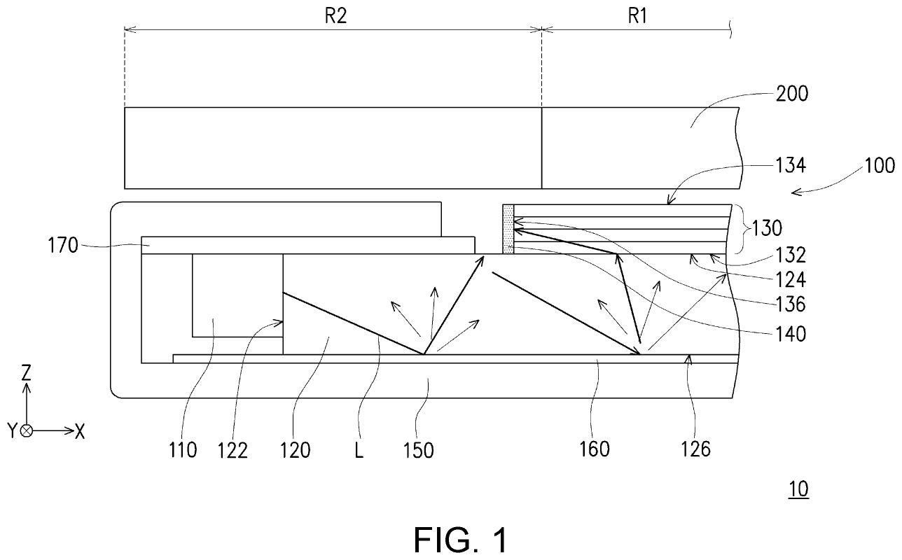

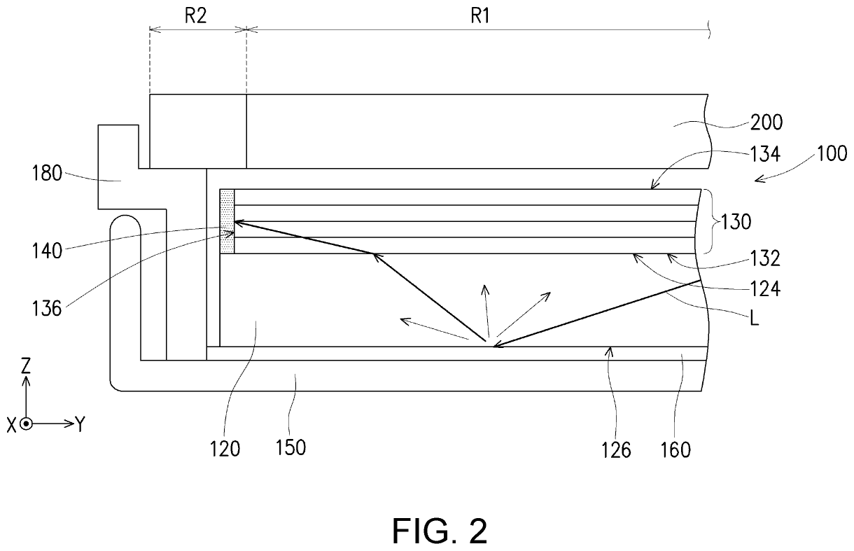

FIG. 1 is a schematic partial cross-sectional view taken along a direction perpendicular to a light-incident surface of a light guide plate in a display apparatus according to an embodiment of the invention. FIG. 2 is a schematic partial cross-sectional view taken along a direction parallel to the light-incident surface of the light guide plate in the display apparatus according to an embodiment of the invention. Referring to FIGS. 1 and 2, a display apparatus 10 according to an embodiment of the invention includes a backlight module 100 and a display panel 200. The display panel 200 is disposed on a light-emitting side of the backlight module 100. The backlight module 100 is configured to provide the display panel 200 with light as a backlight source. In the embodiment, the display panel 200 is a liquid crystal display panel or a quantum dot display panel, for example. However, the invention is not limited thereto. The display panel 200 has a visible region R1 and an ineffective region R2. The visible region R1 is a region in which the display panel 200 may display an image. The ineffective region R2 is a region in which the display panel 200 does not display an image. In addition, the ineffective region R2 surrounds the visible region R1. In an embodiment, taking the display apparatus 10 with a narrow bezel as an example, the width of the ineffective region R2 is less than 3 millimeters.

In the embodiment, the backlight module 100 includes a light source 110, a light guide plate 120, an optical film set 130, and at least one optical film layer 140. In the embodiment, the light source 110 may be a light-emitting diode (LED), a mini LED, or a micro LED. However, the invention is not limited thereto.

In the embodiment, the material of the light guide plate 120 may include plastics, glass, or other suitable materials for a light beam to pass through. However, the invention is not limited thereto. The light guide plate 120 has a light-incident surface 122 and a light-emitting surface 124 adjacent to the light-incident surface 122. The light source 110 is disposed on a side of the light-incident surface 122 of the light guide plate 120, and is configured to emit a light beam L. In addition, the light-incident surface 122 of the light guide plate 120 extends along Y-axis, for example. The cross-section shown in FIG. 1 is parallel to the X-Z plane, for example, and the cross-section shown in FIG. 2 is parallel to the Y-Z plane, for example.

In the embodiment, the optical film set 130 is, for example, a film set formed by stacking a diffusion sheet, an optical brightness enhancement film, a prism sheet, or a wavelength conversion film. However, the invention is not limited thereto. In an embodiment, the optical film set 130 may be formed by stacking one or more types of optical films. In another embodiment, the optical film set 130 may include only one optical film. In the embodiment, the optical film set 130 includes a first surface 132, a second surface 134, and at least one side surface 136. The first surface 132 is opposite to the second surface 134, and the side surface 136 is connected between the first surface 132 and the second surface 134. The optical film set 130 is disposed on a side of the light-emitting surface 124 of the light guide plate 120, and the first surface 132 faces the light-emitting surface 124. More specifically, in the embodiment shown in FIG. 1, the optical film set 130 includes multiple optical films, for example. The first surface 132 is the lower surface of the optical film closest to the light guide plate 120, the second surface 134 is the upper surface of the optical film most distant from the light guide plate 120, and the side surface 136 is a side surface of multiple optical films.

In the embodiment, the optical film layer 140 is disposed on the side surface 136 of the optical film set 130. The optical film layer 140 is, for example, a particle structure layer formed by ink-jet printing (or other suitable methods). More specifically, the optical film layer 140 is a particle structure layer formed by stacking particles. Therefore, the adhesion of the optical film layer 140 to the optical film set 130 is reinforced, and the chance that the optical film layer 140 is peeled off is reduced. Besides, in an embodiment, the optical film layer 140 is located within the orthogonal projection of the ineffective region R2 of the display panel 200 on the light guide plate 120, so as not to affect the image displayed in the visible region R1 of the display panel 200.

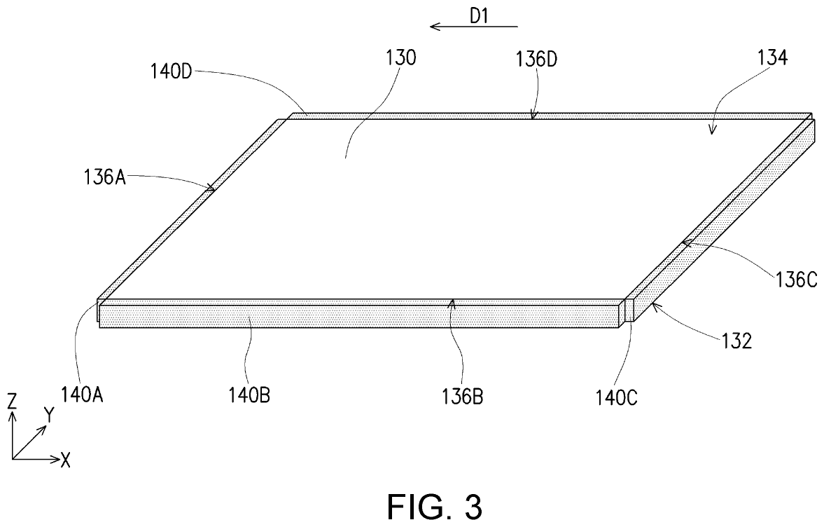

FIG. 3 is a schematic view illustrating an optical film set provided with an optical film layer. As shown in FIG. 3, optical film layers 140A, 140B, 140C, and 140D are respectively disposed on side surfaces 136A, 136B, 136C, and 136D of the optical film set 130. In another embodiment, the optical film layer may be disposed on at least one of the side surfaces 136A, 136B, 136C, and 136D or on a partial surface of the side surfaces 136A, 136B, 136C, and 136D. However, the invention is not limited thereto. The arrangement and the location of the optical film layer shall be determined in accordance with the design requirements of the backlight module 100 or the display apparatus 10.

Referring to FIGS. 1, 2, and 3, in an embodiment, the color of one of the optical film layers 140A, 140B, 140C, and 140D is a complementary color to the light beam L. For example, in the case where the light beam L is white light, one of the optical film layers 140A, 140B, 140C, and 140D may be a black particle structure layer. In the case where the light beam L is blue light, one of the optical film layers 140A, 140B, 140C, and 140D may be a yellow particle structure layer. In the case where the light beam L is light of other colors, one of the optical film layers 140A, 140B, 140C, and 140D may be a particle structure layer in a color complementary to the color of the light beam L. In addition, in an exemplary embodiment, the particle density of the optical film layers 140A, 140B, 140C, and 140D may be in varied density arrangement. Taking the side surface (e.g., the side surface 136B) on which one (e.g., the optical film layer 140B) of the optical film layers 140A, 140B, 140C, and 140D is correspondingly disposed as an example, given that the side surface 136A faces the light source 110, for example, the particle density of the optical film layer 140B on the side surface 136B gradually increases toward the light source 110 along a first direction D1 (e.g., the negative direction of X-axis). In addition, the first direction D1 is parallel to the side surface 136B and is perpendicular to the direction from the first surface 132 toward the second surface 134b. In other words, the portion of the optical film layer 140B close to the light source 110 has higher particle density. Since the particle density of the optical film layer 140B gradually increases toward the light source 110 along the first direction D1, the shielding effect at the edge of the visible region R1 of the display panel 200 is effectively exerted. In addition, the particle density at the portion close to the light source 110 may be optimized to further facilitate the shielding effect. For example, with such density distribution, a black particle structure layer with higher particle density may absorb light with higher intensity at the location close to the light source 110, so as to suppress light leakage on the edge of the optical film set 130 which leads to a halo effect.

In another embodiment, the color of one of the optical film layers 140A, 140B, 140C, and 140D is the same as the light color of the light beam L. For example, in the case where the light beam L is white light, one of the optical film layers 140A, 140B, 140C, and 140D may be a white particle structure layer. In the case where the light beam L is blue light, one of the optical film layers 140A, 140B, 140C, and 140D may be a blue particle structure layer. In the case where the light beam L is light of other colors, one of the optical film layers 140A, 140B, 140C, and 140D may be a particle structure layer in a color same as the color of the light beam L. In addition, in an exemplary embodiment, the particle density of the optical film layers 140A, 140B, 140C, and 140D may be in varied density arrangement. Taking the side surface (e.g., the side surface 136B) on which one (e.g., the optical film layer 140B) of the optical film layers 140A, 140B, 140C, and 140D is correspondingly disposed as an example, given that the side surface 136A faces the light source 110, for example, the particle density of the optical film layer 140B on the side surface 136B gradually decreases toward the light source 110 along the first direction D1. In other words, the portion of the optical film layer 140B close to the light source 110 has lower particle density. Since the particle density of the optical film layer 140B gradually decreases toward the light source 110 along the first direction D1, the shielding effect for the display panel 200 at the edge of the visible region R1 and close to the light source 110 is effectively exerted. In addition, the particle density away from the light source 110 may be optimized to reflect light of lower intensity back to the visible region R1. As a result, the overall light uniformity of the visible region R1 is facilitated. For example, with such density distribution, a white particle structure layer with higher particle density may be adopted to reflect light of lower intensity away from the light source 110. In this way, the halo effect may not occur on the edge of the optical film set 130 due to excessively concentrated bright halo, and the light beam reflected by the white particle structure layer may be used again to increase the light-emitting intensity of the backlight module 100. Moreover, in other embodiments, when the light beam L emitted by the light source is blue light (or light of other colors) and the material of the light guide plate 120 has a higher blue light (or some other color light of the light beam L) absorption rate, the light emission intensity of the backlight module 100 may be increased by providing the blue (or color lights corresponding to some other color light of the light beam L) optical film layer 140B.

In yet another embodiment, on the side surface on which one of the optical film layers 140A, 140B, 140C, and 140D is correspondingly disposed, the particle intensity of the optical film layer is in a periodic distribution in the first direction D1. Taking the optical film layer 140A or 140C as an example, it is assumed that the side surface 136A faces toward the light source 110, and the side surface 136C faces away from the light source 110. Since the light source 110 may include multiple light-emitting devices, by designing the particle density of the optical film layer 140A or 140C to be in a periodic distribution, the density distribution of the particles of the optical film layer 140A or 140C may be adjusted in correspondence with the light-emitting ranges or light-emitting intensity of the light-emitting devices, so as to appropriately reflect or absorb light. In this way, the overall light uniformity of the visible region R1 of the display apparatus 10 is further enhanced.

In other embodiments, the display panel 200 may be a heteromorphic panel and not rectangular. In addition, the shape of the light guide plate 120 may correspond to the shape of the display panel 200 and be non-rectangular. Moreover, the shape of the optical film set 130 may also be non-rectangular, such as having an ear structure. At this time, the corner of the visible region R1 corresponding to the ear structure in the display apparatus may be too bright. Therefore, the optical film layer 140 in a compensatory color to the light beam L may be provided at the ear structure to shield and absorb light. Alternatively, the ear structures may be provided at an interval. Under such circumstance, the particle density of the optical film layer 140 may also change correspondingly.

Moreover, in an embodiment, the colors of the optical film layers 140A, 140B, 140C, and 140D may be the same, or one of the optical film layers 140A, 140B, 140C, and 140D may have a color different from the colors of rest of the optical film layers 140A, 140B, 140C, and 140D. However, the invention is not limited thereto. The color of each of the optical film layers 140A, 140B, 140C, and 140D may be determined in accordance with the design requirements of the backlight module 100 or the display apparatus 10.

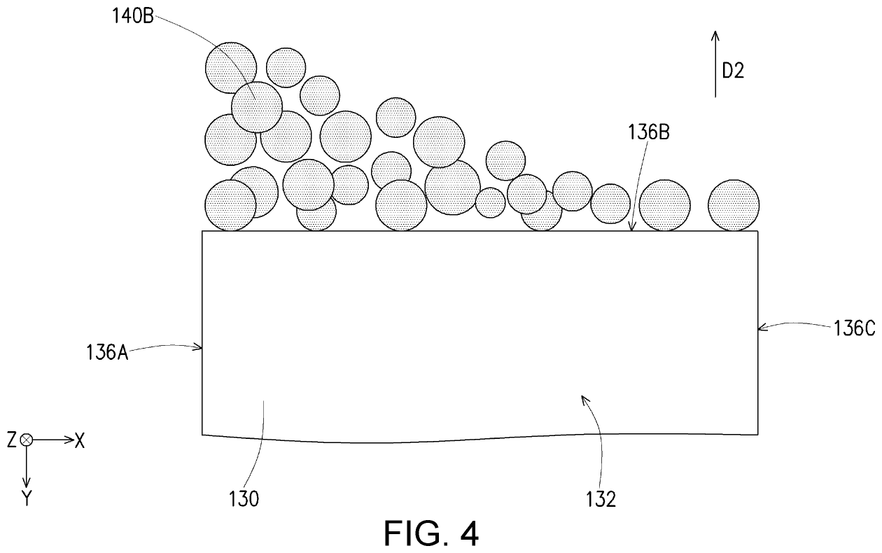

FIG. 4 is a schematic side view illustrating particles stacking in the optical film layer. Referring to FIG. 4, FIG. 4 illustrates the configuration of particles stacking from the perspective of the X-Y plane. Taking the side surface (e.g., the side surface 136B) on which one (e.g., the optical film layer 140B) of the optical film layers 140A, 140B, 140C, and 140D is correspondingly disposed as an example, on the side surface 136B, the thickness of the particle structure of the optical film layer 140B distributed in a second direction D2 (e.g., the negative direction of Y-axis) perpendicular to the side surface 136B varies. In FIG. 4, the particle structure of the optical film layer 140B forms a particle stack layer, and exhibits a three-dimensional density structure. Since the thickness distribution of the optical film layer 140B in the second direction D2 may be optimized according to design requirements, the backlight module 100 according to an embodiment of the invention has favorable light-emitting performance and exhibits enhanced light uniformity. Accordingly, the display apparatus 10 adopting the backlight module 100 according to an embodiment of the invention exhibits a favorable display effect.

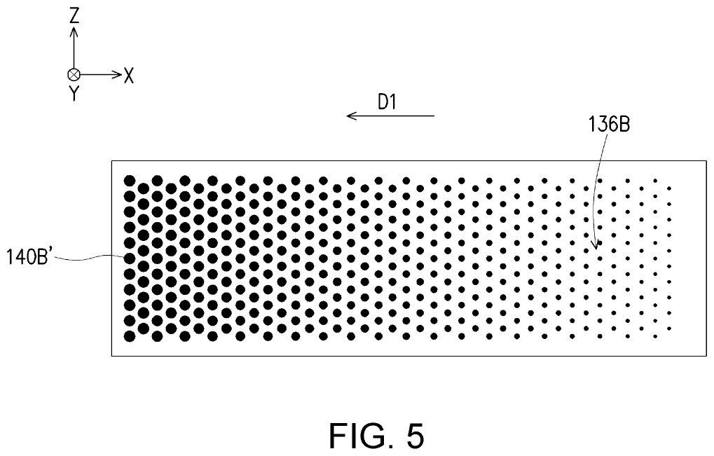

In other embodiments, a particle stack layer formed by the particle structure of the optical film layer 140B may also exhibit a two-dimensional density structure. In other words, the thickness distribution of the optical film layer 140B in the second direction D2 shown in FIG. 4 may be substantially the same, and the density only varies two-dimensionally, such as an optical film layer 140B′ shown in FIG. 5 to be described in the following. FIG. 5 is a schematic top view illustrating particles stacking in the optical film layer. Referring to FIG. 5, FIG. 5 illustrates the configuration of particles stacking in a two-dimensional density structure from a perspective of the X-Z plane. In FIG. 5, the first direction D1 is, for example, the negative direction of X-axis, i.e., the direction toward the light source 110. In FIG. 5, the optical film layer 140B′ is disposed on the side surface 136B, and the particle density of the optical film layer 140B′ gradually increases toward the light source 110 along the first direction D1. More specifically, the thickness of the particle structure of the optical film layer 140B′ distributed in the Y-axis direction remains substantially the same (not shown in the perspective of FIG. 5). The particle structure of the optical film layer 140B′ merely exhibits a density change in the distribution on the X-Z plane to form a two-dimensional density structure. In other embodiments, the particle density of the optical film layer 140B′ may also gradually decrease toward the light source 110 along the first direction D1.

More specifically, since the optical film layer 140 is a particle structure layer (e.g., the optical film layer 140B shown in FIG. 4) formed by particles stacking, the surface of the optical film layer 140 is a rough surface. In other words, the surface of the optical film layer 140 may exhibit a degree of roughness resulting from the curved surfaces of particles. Accordingly, the absorption or reflection of light may be increased. More specifically, forming a particle structure layer by stacking helps control layer thickness and thereby avoid excessive coating. In addition, the particle size of the optical film layer 140B may be within a range from 10 micrometers to 300 micrometers.

Referring to FIGS. 1 and 2 again, in the embodiment, the backlight module 100 further includes a circuit board 170, a back plate 150, a reflective sheet 160, and a plastic frame 180. The circuit board 170 is a printed circuit board or a flexible printed circuit (FPC). The circuit board 170 is disposed on the light-emitting surface 124 of the light guide plate 120 and electrically connected with the light source 110. The light guide plate 120 is disposed on the back plate 150. The reflective sheet 160 is disposed between the back plate 150 and the bottom surface 126 of the light guide plate 120 to prevent the light beam L from being emitted through the bottom surface 126 of the light guide plate 120 and causing light energy loss. With such arrangement, the light energy is used more efficiently. The plastic frame 180 is assembled on the back plate 150 and is configured to accommodate and fix the light guide plate 120 and the optical film set 130. In addition, the plastic frame 180 may be adopted to hold the display panel 200.

In view of the foregoing, in the backlight module according to an embodiment of the invention, since at least one optical film layer is disposed on at least one side surface of the optical film set, the occurrence of a halo effect due to light leakage on the edge of the optical film set may be suppressed. In addition, since the optical film layer is a particle structure layer, the adhesion of the optical film layer to the optical film set is enhanced. Thus, the chance that the optical film layer is peeled off is reduced. In addition, in the backlight module, the stacking of the optical film layer, such as setting higher or lower density close to the light source, may be determined in accordance with design requirements. Therefore, the overall brightness and uniformity of the backlight module is facilitated.

Since the display apparatus according to an embodiment of the invention adopts the backlight module, the display apparatus has a favorable display effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A backlight module, comprising a light source, a light guide plate, an optical film set, and at least one optical film layer,
wherein the light guide plate has a light-incident surface and a light-emitting surface adjacent to the light-incident surface,
the light source is disposed on a side of the light-incident surface of the light guide plate, and is configured to emit a light beam,
the optical film set comprises a first surface, a second surface and at least one side surface, wherein the first surface is opposite to the second surface, the at least one side surface is connected between the first surface and the second surface, the optical film set is disposed on a side of the light-emitting surface of the light guide plate, and the first surface faces the light-emitting surface, and
the at least one optical film layer is disposed on the at least one side surface of the optical film set,
wherein the at least one optical film layer is a particle structure layer.

2. The backlight module as claimed in claim 1, wherein a surface of the at least one optical film layer is a rough surface.

3. The backlight module as claimed in claim 1, wherein a particle size of the at least one optical film layer is in a range from 10 micrometers to 300 micrometers.

4. The backlight module as claimed in claim 1, wherein a color of one of the at least one optical film layer is a complementary color to the light beam.

5. The backlight module as claimed in claim 1, wherein on a side surface on which one of the at least one optical film layer is correspondingly disposed, a particle density of the one of the at least one optical film layer gradually increases toward the light source along a first direction, wherein the first direction is parallel to the side surface and perpendicular to a direction from the first surface toward the second surface.

6. The backlight module as claimed in claim 1, wherein a color of one of the at least one optical film layer is same as a light color of the light beam.

7. The backlight module as claimed in claim 1, wherein on a side surface on which one of the at least one optical film layer is correspondingly disposed, a particle density of the one of the at least one optical film layer gradually decreases toward the light source along a first direction, wherein the first direction is parallel to the side surface and perpendicular to a direction from the first surface toward the second surface.

8. The backlight module as claimed in claim 1, wherein on a side surface on which one of the at least one optical film layer is correspondingly disposed, a particle density of the one of the at least one optical film layer is in a periodic distribution in a first direction, and the first direction is parallel to the side surface and perpendicularly to a direction from the first surface toward the second surface.

9. The backlight module as claimed in claim 1, wherein on a side surface on which one of the at least one optical film layer is correspondingly disposed, a thickness of a particle structure of the one of the at least one optical film layer distributed in a second direction perpendicular to the side surface varies.

10. A display apparatus, comprising a backlight module and a display panel,
wherein the display panel is disposed on a light-emitting side of the backlight module, and
the backlight module comprises a light source, a light guide plate, an optical film set, and at least one optical film layer,
wherein the light guide plate has a light-incident surface and a light-emitting surface adjacent to the light-incident surface,
the light source is disposed on a side of the light-incident surface of the light guide plate, and is configured to emit a light beam,
the optical film set comprises a first surface, a second surface and at least one side surface, wherein the first surface is opposite to the second surface, the at least one side surface is connected between the first surface and the second surface, the optical film set is disposed on a side of the light-emitting surface of the light guide plate, and the first surface faces the light-emitting surface, and
the at least one optical film layer is disposed on the at least one side surface of the optical film set,
wherein the at least one optical film layer is a particle structure layer.

11. The display apparatus as claimed in claim 10, wherein a surface of the at least one optical film layer is a rough surface.

12. The display apparatus as claimed in claim 10, wherein a particle size of the at least one optical film layer is in a range from 10 micrometers to 300 micrometers.

13. The display apparatus as claimed in claim 10, wherein a color of one of the at least one optical film layer is a complementary color to the light beam.

14. The display apparatus as claimed in claim 10, wherein on a side surface on which one of the at least one optical film layer is correspondingly disposed, a particle density of the one of the at least one optical film layer gradually increases toward the light source along a first direction, wherein the first direction is parallel to the side surface and perpendicular to a direction from the first surface toward the second surface.

15. The display apparatus as claimed in claim 10, wherein a color of one of the at least one optical film layer is same as a light color of the light beam.

16. The display apparatus as claimed in claim 10, wherein on a side surface on which one of the at least one optical film layer is correspondingly disposed, a particle density of the one of the at least one optical film layer gradually decreases toward the light source along a first direction, wherein the first direction is parallel to the side surface and perpendicular to a direction from the first surface toward the second surface.

17. The display apparatus as claimed in claim 10, wherein on a side surface on which one of the at least one optical film layer is correspondingly disposed, a particle density of the one of the at least one optical film layer is in a periodic distribution in a first direction, and the first direction is parallel to the side surface and perpendicularly to a direction from the first surface toward the second surface.

18. The display apparatus as claimed in claim 10, wherein on a side surface on which one of the at least one optical film layer is correspondingly disposed, a thickness of a particle structure of the one of the at least one optical film layer distributed in a second direction perpendicular to the side surface varies.
